(19) United States
(12) Patent Application Publication
(10) Pub. No.: US 2017/0107126 A1
(43) Pub. Date: Apr. 20, 2017

(54) DISPERSANT FOR WATER TREATMENT AND WATER TREATMENT METHOD

(71) Applicant: KURITA WATER INDUSTRIES LTD., Tokyo (JP)

(72) Inventors: Akihiro FUJII, Tokyo (JP); Takahiro KAWAKATSU, Tokyo (JP)

(21) Appl. No.: 15/127,254

(22) PCT Filed: Mar. 13, 2015
(86) PCT No.: PCT/JP2015/057420

§ 371 Date: Sep. 19, 2016

(30) Foreign Application Priority Data
Mar. 18, 2014 (JP) 2014-055253

(51) Int. Cl. C02F 1/52; C02F 5/12; B01D 65/08; C08L 71/02; C08L 33/26; C08L 79/02; C08L 61/06; C02F 1/44; C08L 39/06

(52) U.S. Cl. CPC C02F 1/5272; C02F 1/44; C02F 5/12; B01D 65/08; C08L 39/06; C08L 33/26; C08L 79/02; C08L 61/06; C08L 71/02; C02F 2101/345

(57) ABSTRACT

An object of the present invention is to provide a dispersant for treatment of water. The dispersant is used in a membrane separation process of water containing an organic compound having a phenolic hydroxy group and prevents a reduction in amount of the water permeating a separation membrane, which is caused by deposition of the organic compound onto the surface of the separation membrane. Provided are a dispersant for treatment of water containing an organic compound having a phenolic hydroxy group wherein the dispersant contains a polymer compound having a carbonyl group and a structure including a nitrogen atom bonded to a carbonyl carbon atom; and a method for treatment of water containing an organic compound having a phenolic hydroxy group, wherein the method includes adding the dispersant to the water.

### TECHNICAL FIELD

The present invention relates to a dispersant for treatment of water and a method for treatment of water.

### BACKGROUND ART

Polyphenols are present in humic substances contained in soil and are used as raw materials for foods and beverages in food and beverage plants.

Thus, surface water or groundwater containing humic substances or waste water from a food or beverage plant may contain organic compounds having a phenolic hydroxy group, such as polyphenols.

PTL 1 discloses a method for treatment of water, the method including a flocculation process and the subsequent membrane separation process, wherein the flocculation process involves addition of a flocculant to water to be treated, the flocculant containing an alkali solution of a phenolic resin having a melting point of 130 to 220° C. The water treated by flocculation, which contains the remaining flocculant, contains organic compounds having a phenolic hydroxy group.

For example, PTL 2 discloses a technique regarding a polymeric porous hollow fiber membrane composed of polysulfone and polyvinylpyrrolidone and exhibiting specific adsorbability to polyphenols, wherein the hollow fiber membrane is used for the filtration of a beverage containing polyphenols derived from raw materials for foods and beverages.

### CITATION LIST

### Patent Literature

PTL 1: Japanese Unexamined Patent Application Publication No. 2011-56496

PTL 2: Japanese Unexamined Patent Application Publication No. 2008-284471

### SUMMARY OF INVENTION

The present invention provides a dispersant for treatment of water containing an organic compound having a phenolic hydroxy group, the dispersant comprising a polymer compound having a carbonyl group and a structure including a nitrogen atom bonded to a carbonyl carbon atom.

The present invention also provides a method for treatment of water containing an organic compound having a phenolic hydroxy group, the method comprising adding the dispersant of the present invention to the water.

### BRIEF DESCRIPTION OF DRAWINGS

FIG. 1A is a schematic view illustrating the polarization of PVP.

FIG. 1B is a schematic view illustrating the interaction between PVP and polyphenol via hydrogen bonds.

FIG. 2A is a schematic view illustrating the mechanism of action of a dispersant for treatment of water in the case where an organic compound having a phenolic hydroxy group is dissolved or dispersed alone in water to be treated.

FIG. 2B is a schematic view illustrating the mechanism of action of a dispersant for treatment of water in the case where an organic compound having a phenolic hydroxy group is dispersed in the form of flocculates in water to be treated, the organic compound being bonded to another organic substance or metal contained in the water.

FIG. 2C is a schematic view illustrating the mechanism of action of a dispersant for treatment of water when the dispersant is bonded to an organic compound having a phenolic hydroxy group.

FIG. 3 is a flow diagram illustrating a process involving addition of a dispersant for treatment of water before treatment with a reverse osmosis membrane separation apparatus.

FIG. 4 is a set of photographs (substitute for drawing) illustrating the effect of a dispersant for treatment of water on a novolac phenolic resin flocculant in Experimental Example 1.

FIG. 5 is a photograph (substitute for drawing) illustrating the effect of a dispersant for treatment of water on humic acid in Experimental Example 2.

FIG. 6 is a flow diagram of a water treatment system simulated in Experimental Example 3 and including a flocculation apparatus, a solid-liquid separation apparatus, a microfiltration membrane separation apparatus, and a reverse osmosis membrane separation apparatus.

FIG. 7 is a graph illustrating the relationship between the amount of added PVP and the filtration time determined in Experimental Example 3.

FIG. 8 is a graph illustrating the relationship between the amount of added PVP and the absorbance determined in Experimental Example 3.

FIG. 9 is a schematic view illustrating the configuration of a flat membrane tester used in Experimental Example 4.

FIG. 10 is a graph illustrating the relationship between the flux ratio and the water passing time determined in Experimental Example 4.

### DESCRIPTION OF EMBODIMENTS

The dispersant for treatment of water according to an embodiment of the present invention may comprise at least one of the polymer compounds represented by Formulae (1) to (3):

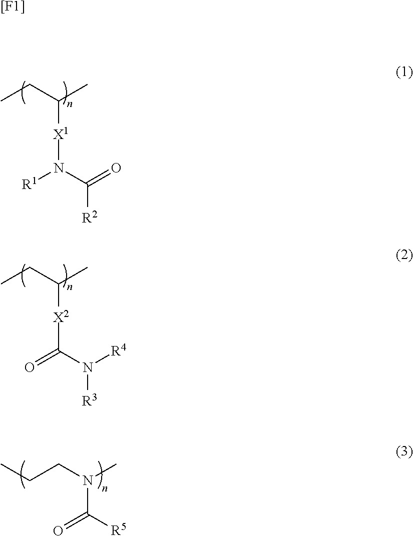

where X¹ and X² each represent a single bond or an alkylene group having one or two carbon atoms and optionally having a substituent; R¹ to R⁵ each represent a hydrogen atom or an alkyl group having one to three carbon atoms and optionally having a substituent; R¹ and R² may be identical to or different from each other and may be bonded together to form a 5- to 7-membered cyclic amide structure; and R³ and R⁴ may be identical to or different from each other and may be bonded together to form a 5- to 7-membered cyclic amide structure.

The polymer compound may comprise polyvinylpyrrolidone and/or polyacrylamide. The polymer compound may have a mass average molecular weight of 7,000 to 2,000,000.

The dispersant for treatment of water may further comprise a scale inhibitor.

The dispersant for treatment of water according to the embodiment of the present invention may be used in a membrane separation process.

In the method for treatment of water according to the embodiment of the present invention, water to be treated may be water to be supplied to a membrane separation process.

Conventional techniques have the following problems:

(1) Humic substances contained in soil are polyphenols having a carboxy group, and the treatment of water containing organic compounds having a phenolic hydroxy group (e.g., polyphenols) with a separation membrane (e.g., a microfiltration membrane) may cause membrane fouling.

(2) The treatment of water containing polyphenols derived from raw materials for foods and beverages with a separation membrane (e.g., a microfiltration membrane) may also cause fouling of the separation membrane due to, for example, the interaction between polysaccharides and polyphenols contained in a fermented liquor, such as wine. The technique disclosed in PTL 2 is mainly used for the production of beverages, and some polyphenols contained in water to be treated pass through the filtration membrane. This technique encounters difficulty in preventing a reduction in amount of water permeating the filtration membrane caused by adsorption of polyphenols onto the membrane (and thus deposition of the polyphenols onto the membrane).

In order to solve such problems, a main object of the present invention is to provide a dispersant for treatment of water that is used in a membrane separation process of water containing an organic compound having a phenolic hydroxy group and that prevents a reduction in amount of the water permeating a separation membrane, which is caused by deposition of the organic compound onto the surface of the separation membrane.

In an embodiment, the present invention can provide a dispersant for treatment of water that is used in a membrane separation process of water containing an organic compound having a phenolic hydroxy group and that prevents a reduction in amount of the water permeating a separation membrane, which is caused by deposition of the organic compound onto the surface of the separation membrane.

Embodiments of the present invention will now be described. The following embodiments are merely typical embodiments of the present invention and should not be construed to limit the present invention.

### <Dispersant for Treatment of Water>

The dispersant for treatment of water (hereinafter may be referred to simply as “dispersant”) according to an embodiment of the present invention comprises a polymer compound having a carbonyl group and a structure including a nitrogen atom bonded to a carbonyl carbon atom. The dispersant is used for water containing an organic compound having a phenolic hydroxy group.

Examples of the organic compound having a phenolic hydroxy group will be described below. Typical examples of the organic compound are polyphenols.

Polyphenols having a carboxy group are present in humic substances contained in soil. Such polyphenols may cause the fouling of a separation membrane, such as a microfiltration membrane (MF membrane), an ultrafiltration membrane (UF membrane), a nanofiltration membrane (NF membrane), or a reverse osmosis membrane (RO membrane). The term “fouling” refers to a phenomenon that substances to be separated, which are present in water supplied to a membrane (e.g., raw water), are deposited onto the surface of the membrane or in pores of the membrane. Examples of the fouling include the deposition of suspended particles onto the surface of a membrane, the formation of a layer through adsorption of suspended particles onto a membrane, the gelation of a soluble polymer substance on the surface of a membrane, the blocking of pores of a membrane caused by adsorption, precipitation, occlusion, or bubbles in the pores, and the flow channel clogging in a module.

Humic substances can be removed through a flocculation or adsorption process before a membrane separation process. Unfortunately, the flocculation process inefficiently removes a relatively low-molecular-weight organic compound having a phenolic hydroxy group (e.g., fulvic acid), and the adsorption process requires periodic exchange of adsorbents.

A technique has been proposed for the treatment of a beverage containing polyphenols derived from raw materials for foods and beverages (i.e., the filtration of a polyphenol-containing beverage for controlling the flavor of the beverage). In detail, this technique involves the incorporation of polyvinylpyrrolidone into a hollow fiber microfiltration membrane to optimize the amount of polyphenols to be adsorbed onto the microfiltration membrane (refer to PTL 2 described above). Another technique has been proposed for removing turbidity-causing polyphenols from a liquor, such as beer or wine. This technique involves the preparation of polyvinylpolypyrrolidone through crosslinking of polyvinylpyrrolidone and the incorporation of polyvinylpolypyrrolidone into the matrix of a microfiltration/ultrafiltration membrane (refer to Japanese Unexamined Patent Application Publication No. H07-171359).

Some studies have reported that the fouling of a microfiltration membrane is caused by the interaction between polysaccharides and polyphenols contained in a fermented liquor, such as wine.

The techniques disclosed in PTL 2 and Japanese Unexamined Patent Application Publication No. H07-171359 impart the adsorption ability of polyphenols to a filtration membrane for removal of polyphenols. These techniques are mainly used for the production of beverages, and some polyphenols contained in water to be treated pass through the filtration membrane. These techniques cannot prevent a reduction in amount of water permeating the filtration membrane caused by adsorption of polyphenols onto the membrane (and thus deposition of the polyphenols onto the membrane).

None of these patent literature discloses the use of polyvinylpyrrolidone (PVP) or polyvinylpolypyrrolidone (prepared through crosslinking of PVP) as a dispersant for preventing the deposition of polyphenols onto a membrane.

The membrane separation process of water containing polyphenols derived from humic substances or raw materials for foods and beverages may cause deposition of the polyphenols onto the surface of a separation membrane, resulting in a reduction in amount of water permeating the membrane.

If a novolac phenolic resin is used as a flocculant for the flocculation and solid-liquid separation of organic polymers derived from biological metabolites contained in biologically treated water or seawater as disclosed in PTL 1, the phenolic resin may remain in the water treated by flocculation and may be deposited onto an RO membrane in the subsequent process, resulting in a reduction in amount of water permeating the membrane.

The passing of water containing humic substances through an ion exchange resin column may cause incomplete regeneration of the column due to deposition of the humic substances; i.e., contamination of the column with the humic substances.

In the present invention, the dispersant is used for preventing a reduction in amount of water permeating a separation membrane due to deposition of an organic compound having a phenolic hydroxy group (e.g., polyphenol or novolac phenolic resin) onto the membrane during the membrane separation process of water containing the organic compound that is derived from humic substances or raw materials for foods and beverages.

The addition of the dispersant according to the present embodiment to water containing an organic compound having a phenolic hydroxy group probably leads to bonding of the dispersant to the organic compound by the interaction between the dispersant and the organic compound. The bonding between the dispersant and the organic compound probably prevents deposition of the organic compound onto a separation membrane. The dispersant is preferably added to the water before the membrane separation process in view of preventing the deposition of the organic compound onto the separation membrane.

The dispersant according to the present embodiment may be used for treatment of any water containing an organic compound having a phenolic hydroxy group.

As used herein, the term “phenolic hydroxy group” refers to a hydroxy group bonded to an aromatic ring. Examples of the organic compound having a phenolic hydroxy group include humic acid, fulvic acid, ellagic acid, phenolic acid, tannin, catechin, rutin, anthocyanin, and synthetic phenolic resins.

The organic compound having a phenolic hydroxy group has a molecular weight (in the case of a low-molecular-weight compound) or a mass average molecular weight (in the case of a polymer compound) of preferably 500 to 1,000,000, more preferably 1,000 to 500,000, still more preferably 1,000 to 100,000. The dispersant can effectively disperse an organic compound having a phenolic hydroxy group and a molecular weight or mass average molecular weight of about 500 to 1,000,000 (more preferably 1,000 to 100,000).

In the present disclosure, the mass average molecular weight of an organic compound having a phenolic hydroxy group (i.e., in the case that the organic compound is a polymer, such as polyphenol) is calculated in terms of pullulan by GPC using a calibration curve prepared with pullulan standards.

Preferred examples of the water to be treated for which the dispersant of the present embodiment is used include surface water and groundwater containing humic substances containing polyphenols having a carboxy group, and waste water from food and beverage plants and containing raw-material-derived polyphenols. The technique disclosed in PTL 1 for treatment of water involves addition of a flocculant containing an alkali solution of a phenolic resin in a flocculation process before a membrane separation process. The water treated by flocculation, which contains the remaining phenolic resin (flocculant), is also a preferred example of the water to be treated.

The dispersant according to the present embodiment is preferably used for the aforementioned water to be treated during the membrane separation process or the process using an ion exchange resin, more preferably used for the water to be treated before the membrane separation process or the process using an ion exchange resin. Still more preferably, the dispersant is used for the water to be treated before passing (supply) of the water through, for example, an MF, UF, NF, or RO membrane.

The water to be treated may have any pH value. The water has a pH of preferably 3.5 to 8.5, more preferably 4.0 to 7.5, still more preferably 5.0 to 7.0. The pH of the water to be treated is preferably adjusted to be within the above range through optional addition of an acid and/or an alkali.

The dispersant according to the present embodiment comprises a polymer compound having a carbonyl group and a structure including a nitrogen atom bonded to a carbonyl carbon atom. The dispersant may substantially consist of the polymer compound, which serves as an active component that can prevent a reduction in amount of water permeating a separation membrane. Alternatively, the dispersant may comprise any additional component that does not impair the object of the present invention.

The polymer compound can be used as an active component of the dispersant for treatment of water.

The polymer compound that can be used in the dispersant is capable of bonding to an organic compound having a phenolic hydroxy group. The polymer compound preferably has properties (e.g., hydrophilicity) that prevent contamination of a separation membrane during the membrane separation process. From such viewpoints, the polymer compound is preferably polyvinylpyrrolidone (PVP).

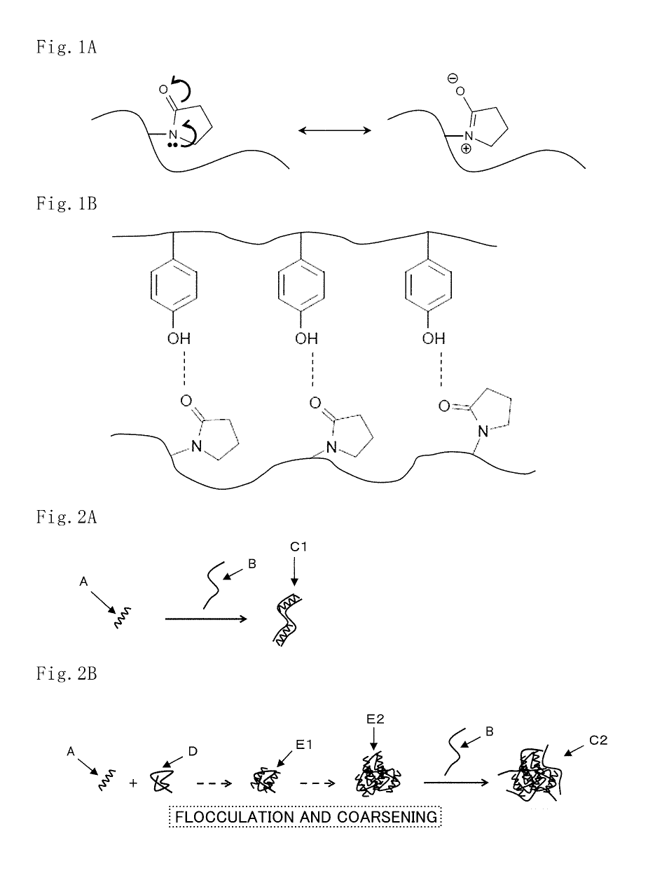

The bonding between PVP and polyphenol is probably attributed to the interaction between carbonyl groups of PVP and phenolic hydroxy groups of the polyphenol via hydrogen bonds. FIG. 1A is a schematic view illustrating the polarization of PVP. FIG. 1B is a schematic view illustrating the interaction between polarized PVP and polyphenol via hydrogen bonds.

The polymer compound has a structure including a nitrogen atom bonded to a carbonyl carbon atom as described above. The polymer compound preferably has the structure in the main or side chain.

Polymer compounds that have a structure including a nitrogen atom bonded to a carbonyl carbon atom and are suitable for the object of the present invention will now be described with reference to Formulae (1) to (3).

The polymer compound having, in the side chain, a structure including a nitrogen atom bonded to a carbonyl carbon atom is preferably a polymer compound represented by Formula (1).

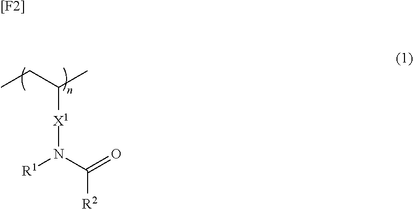

In Formula (1), X¹ represents a single bond or an alkylene group having one or two carbon atoms and optionally having a substituent. R¹ and R² each represent a hydrogen atom or an alkyl group having one to three carbon atoms and optionally having a substituent. R¹ and R² may be identical to or different from each other and may be bonded together to form a 5- to 7-membered cyclic amide structure. In Formula (1), n is an integer representing the number of repeating units; for example, an integer of 10 or more.

The alkyl group having one to three carbon atoms represented by R¹ or R² may have a linear, branched, or cyclic structure. The alkyl group preferably has a linear or branched structure. Examples of the alkyl group include methyl, ethyl, n-propyl, and isopropyl groups.

As used herein, the term “substituent” may be of any type. Examples of the substituent include halogen atoms (e.g., F, Cl, and Br) and hydroxy, oxo, carboxy, sulfo, phosphate, amino, cyano, and nitro groups. The expression “optionally having a substituent” includes the case of having one or more substituents.

In the polymer compound represented by Formula (1), X¹ is preferably a single bond. R¹ and R² are each preferably a hydrogen atom or a methyl group, and R¹ and R² are also preferably bonded together to form a 5- to 7-membered cyclic amide structure.

Preferred examples of the polymer compound represented by Formula (1) include polyvinylpyrrolidone, polyvinylpiperidone, polyvinylcaprolactam, polyvinylformamide, and polyvinylacetamide. These polymer compounds may be used alone or in combination.

The polymer compound represented by Formula (1) is more preferably polyvinylpyrrolidone.

The polymer compound having, in the side chain, a structure including a nitrogen atom bonded to a carbonyl carbon atom is also preferably a polymer compound represented by Formula (2).

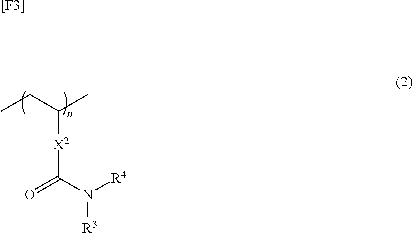

In Formula (2), X² represents a single bond or an alkylene group having one or two carbon atoms and optionally having a substituent. R³ and R⁴ each represent a hydrogen atom or an alkyl group having one to three carbon atoms and optionally having a substituent. R³ and R⁴ may be identical to or different from each other and may be bonded together to form a 5- to 7-membered cyclic amide structure. In Formula (1), n is an integer representing the number of repeating units; for example, an integer of 10 or more.

The alkyl group having one to three carbon atoms represented by R³ or R⁴ may have a linear, branched, or cyclic structure. The alkyl group preferably has a linear or branched structure. Examples of the alkyl group include methyl, ethyl, n-propyl, and isopropyl groups.

In the polymer compound represented by Formula (2), X² is preferably a single bond. R³ and R⁴ are each preferably a hydrogen atom or an alkyl group having one to three carbon atoms. R³ and R⁴ are also preferably bonded together to form a 5- to 7-membered cyclic amide structure.

Preferred examples of the polymer compound represented by Formula (2) include polyacrylamide, polymethacrylamide, polyacryloylmorpholine, polyisopropylacrylamide, and polydiethylacrylamide. These polymer compounds may be used alone or in combination.

The polymer compound represented by Formula (2) is more preferably polyacrylamide.

The polymer compound having, in the main chain, a structure including a nitrogen atom bonded to a carbonyl carbon atom is preferably a polymer compound represented by Formula (3).

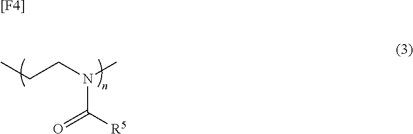

In Formula (3), R⁵ represents an alkyl group having one to three carbon atoms and optionally having a substituent, and n is an integer representing the number of repeating units; for example, an integer of 10 or more.

The alkyl group having one to three carbon atoms represented by R⁵ may have a linear, branched, or cyclic structure. The alkyl group preferably has a linear or branched structure. Examples of the alkyl group include methyl, ethyl, n-propyl, and isopropyl groups.

Preferred examples of the polymer compound represented by Formula (3) include poly(2-alkyl-2-oxazoline)s, such as poly(2-ethyl-2-oxazoline) and poly(2-propyl-2-oxazoline). These polymer compounds may be used alone or in combination.

The polymer compound represented by Formula (3) is more preferably poly(2-ethyl-2-oxazoline).

The aforementioned polymer compounds may be used alone or in combination. The aforementioned polymer compounds are more preferably polyvinylpyrrolidone and/or polyacrylamide.

The aforementioned polymer compounds may be produced or polymerized by any process. The polymer compounds represented by Formulae (1) to (3) can be prepared through polymerization of predetermined amounts of monomer components providing the structural units of Formulae (1) to (3), respectively. For example, polyvinylpyrrolidone can be prepared through polymerization of N-vinyl-2-pyrrolidone, and polyacrylamide can be prepared through polymerization of acrylamide. The aforementioned polymer compounds may be commercially available products.

The polymer compound used for water to be treated is preferably determined in consideration of the size and amount of an organic compound having a phenolic hydroxy group contained in the water. For example, a polymer compound having an appropriate mass average molecular weight is preferably used. In the case where the organic compound having a phenolic hydroxy group contained in water to be treated has a low molecular weight, the polymer compound used in the dispersant preferably has a mass average molecular weight as low as about 2,500.

The polymer compound has a mass average molecular weight of preferably 2,000 to 2,000,000, more preferably 7,000 to 2,000,000, still more preferably 7,000 to 1,500,000. The lower limit of the mass average molecular weight of the polymer compound is preferably 2,500, more preferably 5,000, still more preferably 10,000. The upper limit of the mass average molecular weight of the polymer compound is preferably 1,000,000, more preferably 500,000, still more preferably 100,000.

The use of a polymer compound having a mass average molecular weight of 2,000 to 2,000,000 in the dispersant probably facilitates bonding of the dispersant to an organic compound having a phenolic hydroxy group contained in water to be treated, resulting in enhanced dispersion effect.

In the present disclosure, the mass average molecular weight of the polymer compound is calculated in terms of pullulan by GPC using a calibration curve prepared with pullulan standards.

The dispersant for treatment of water according to the present embodiment, which contains the aforementioned polymer compound, may contain any additional compound, such as a scale inhibitor (illustrated below), a solvent (e.g., water) or a dispersive medium, or a slime-controlling agent.

The dispersant may be of a single-dosage type containing the polymer compound and an additional component together, or may be of a multi-dosage type (e.g., a kit) in which the polymer compound and the additional component are separately provided. The single-dosage type is readily handled during use. The timing and amount of the multi-dosage type used for water to be treated are readily adjusted in accordance with the quality of the water because the polymer compound and the additional component can be separately added.

The dispersant may be in any form, such as a liquid, solid, or semisolid form. For example, the polymer compound and additional component (e.g., scale inhibitor illustrated below) used in the dispersant may be provided in the form of a solid or a solution or dispersion in a solvent (e.g., water). The dispersant is more preferably in the form of liquid in view of easy preparation of a single-dosage product through mixing of the polymer compound and the additional component, and easy handling of the dispersant (i.e., only addition of the dispersant is required during the use for water to be treated).

The dispersant may contain the polymer compound in any amount. The polymer compound content of the dispersant is preferably 5 to 60 mass %, more preferably 15 to 45 mass %. The polymer compound contained in the dispersant in such a preferred amount reduces the volume of the dispersant and prevents the preparation of a highly viscous solution that is difficult to handle.

The dispersant according to the present embodiment preferably contains a scale inhibitor. Thus, the dispersant is preferably composed of the aforementioned polymer compound and a scale inhibitor.

The scale inhibitor incorporated into the dispersant probably breaks the crosslinked structure of an organic compound having a phenolic hydroxy group contained in water to be treated, resulting in further enhanced dispersion effect of the polymer compound.

In view of the synergistic effect between the polymer compound and the scale inhibitor, the scale inhibitor is preferably capable of trapping a metal ion (e.g., Ca or Al ion) that forms crosslinks in an organic compound having a phenolic hydroxy group. The scale inhibitor is more preferably at least one of phosphate scale inhibitors and phosphonate scale inhibitors.

Examples of low-molecular-weight scale inhibitors include sodium tripolyphosphate, sodium hexametaphosphate, 2-phosphono-1,2,4-tricarboxybutane, 1-hydroxyethylidene-1,1-diphosphonic acid, and aminotrimethylenephosphonic acid.

Examples of polymeric scale inhibitors include phosphino-carboxylic acid copolymers, acrylic acid-(3-allyloxy-2-hydroxypropanesulfonic acid) copolymers, acrylic acid-(2-acrylamido-2-methylpropanesulfonic acid) copolymers, acrylic acid-(2-acrylamido-2-methylpropanesulfonic acid)-(t-butylacrylamide) copolymers, and maleic acid-alkyl acrylate-vinyl acetate copolymers.

These scale inhibitors may be used alone or in combination.

The scale inhibitor is more preferably 1-hydroxyethylidene-1,1-diphosphonic acid (also called 1-hydroxyethane-1,1-diylbisphosphonic acid (HEDP)) or 2-phosphonobutane-1,2,4-tricarboxylic acid (PBTC).

The PBTC may be, for example, “Kuriverter (registered trademark) N-500” manufactured by Kurita Water Industries Ltd.

The dispersant for treatment of water according to the present embodiment may contain the scale inhibitor in any amount. The scale inhibitor content of the dispersant is preferably 5 to 40 mass %, more preferably 15 to 30 mass %. The scale inhibitor contained in the dispersant in such a preferred amount leads to significant enhancement of the synergistic effect between the polymer compound and the scale inhibitor.

The above-detailed dispersant for treatment of water according to the present embodiment or the components of the dispersant (which are simultaneously or separately added) are effectively applied to water to be treated. This application can treat an organic compound having a phenolic hydroxy group contained in the water.

The use of the dispersant according to the present embodiment or the components of the dispersant for a membrane separation process of the water can prevent a reduction in amount of water permeating a separation membrane, which is caused by the deposition of the organic compound contained in the water onto the membrane.

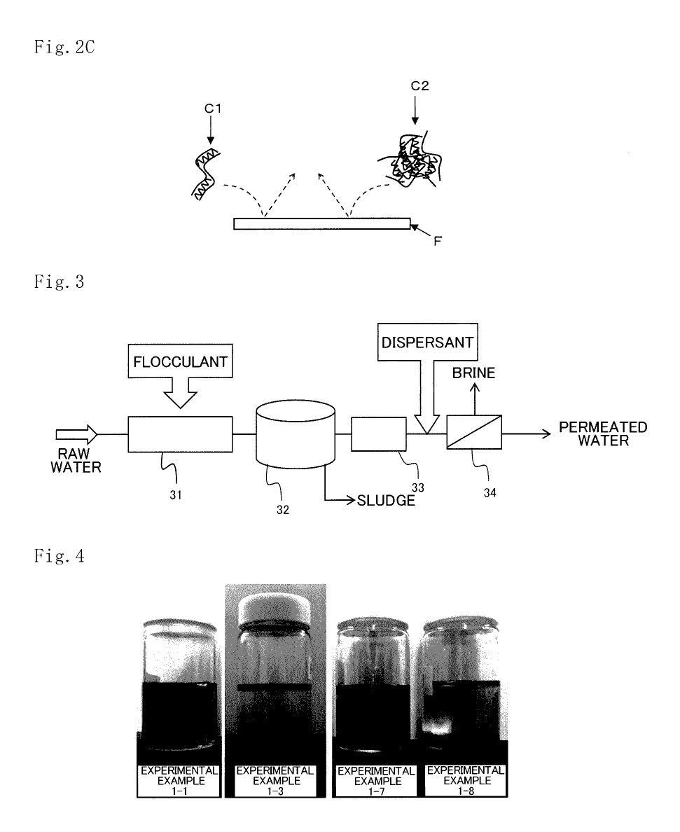

Now will be described a conceivable action mechanism of the dispersant for treatment of water with reference to FIGS. 2A to 2C.

If an organic compound (A) having a phenolic hydroxy group is dissolved or dispersed alone in water to be treated as illustrated in FIG. 2A, molecules of the organic compound (A) contained in the water may be bonded together, resulting in flocculation and coarsening. The bonding of a hydrophilic dispersant (B) according to the present embodiment to the organic compound (A) (refer to C1 in FIG. 2A) probably imparts hydrophilicity to a product (C1) formed through bonding between the organic compound (A) and the dispersant (B), leading to prevention of flocculation and coarsening of the organic compound (A) caused by hydrophobic interaction (refer to FIG. 2A).

If the organic compound (A) is bonded to another organic substance (D) (or a metal) contained in the water to be treated and dispersed in the form of a flocculate (E1) or a coarse flocculate (E2) as illustrated in FIG. 2B, the hydrophilic dispersant (B) according to the present embodiment probably covers the flocculate (E1 or E2) (refer to C2 in FIG. 2B) to prevent further flocculation and coarsening of the organic compound (A) (refer to FIG. 2B).

As illustrated in FIG. 2C, the prevention of flocculation and coarsening of the organic compound (A) through bonding of the dispersant (B) to the organic compound (A) in the water to be treated probably reduces clogging of a flow channel of a separation membrane module (F) and deposition of the organic compound (A) onto the surface of the separation membrane (F). Also, the prevention of further flocculation and coarsening of the organic compound (A) through covering of the flocculate (E1 or E2) with the dispersant (B) in the water to be treated probably reduces clogging of the flow channel of the separation membrane module (F) and deposition of the organic compound (A) onto the surface of the separation membrane (F).

In the case where water to be treated contains an organic compound having a carboxy group and a phenolic hydroxy group (e.g., fulvic acid), the addition of the dispersant for treatment of water and a scale inhibitor to the organic compound can significantly reduce the deposition of the organic compound onto the surface of the separation membrane by the synergistic effect of the dispersant and the scale inhibitor.

### <Method for Treatment of Water>

The method for treatment of water according to an embodiment of the present invention involves addition of the dispersant for treatment of water containing the aforementioned polymer compound to the aforementioned water to be treated.

The method for treatment of water according to the present embodiment involves addition of the aforementioned dispersant to water to be treated, or simultaneous or separate addition of the components of the dispersant to the water to be treated.

For example, the method for treatment of water according to the present embodiment may involve simultaneous or separate addition of the aforementioned polymer compound and another component (e.g., the aforementioned scale inhibitor) to water to be treated. In the case where the dispersant for treatment of water does not contain the scale inhibitor, the scale inhibitor may be added to water to be treated separately from the addition of the dispersant containing the aforementioned polymer compound.

The dispersant for treatment of water or the components of the dispersant may be added to water containing an organic compound having a phenolic hydroxy group by any process and at any site. The addition of the dispersant or the aforementioned polymer compound used for the dispersant to the water to be treated leads to bonding of the polymer compound to the organic compound having a phenolic hydroxy group contained in the water, resulting in treatment of the water.

The dispersant for treatment of water is preferably added during the treatment of water by a membrane separation process or a process using an ion exchange resin, more preferably added before the membrane separation process.

The addition of the dispersant to water to be treated before the membrane separation process leads to bonding of the dispersant to an organic compound having a phenolic hydroxy group contained in the water, resulting in prevention of deposition of the organic compound onto the separation membrane. This prevents a reduction in amount of water permeating the separation membrane, which is caused by deposition of the organic compound onto the separation membrane.

Examples of the membrane separation process include processes using a microfiltration membrane (MF membrane), an ultrafiltration membrane (UF membrane), a nanofiltration membrane (NF membrane), and a reverse osmosis membrane (RO membrane).

The dispersant is preferably added to water to be treated before passing of the water through an MF, UF, NF, or RO membrane used in the membrane separation process (i.e., water to be supplied to such a separation membrane).

The addition of the dispersant before the membrane separation process (more preferably, the addition of the dispersant to water to be supplied to an MF, UF, NF, or RO membrane) prevents membrane fouling caused by an organic compound having a phenolic hydroxy group.

The dispersant is more preferably added to water to be treated before passing of water through an RO membrane. FIG. 3 is a typical flow diagram in the case of addition of the dispersant to an RO membrane separation apparatus. The flow diagram of FIG. 3 illustrates a flocculation process involving the addition of a flocculant to raw water supplied to an in-line mixer (or reaction vessel) 31, a solid-liquid separation process involving the treatment of the water treated by flocculation with a solid-liquid separation apparatus 32, and a membrane separation process involving the addition of the dispersant to the treated water after a prefilter 33 and before an RO membrane separation apparatus 34.

The addition of the dispersant to water to be treated before passing of the water through the RO membrane leads to bonding of the dispersant to an organic compound having a phenolic hydroxy group. The organic compound is discharged with brine water without being deposited onto the RO membrane or the RO membrane separation apparatus (module).

The aforementioned polymer compound may be added to water to be treated in any amount. The amount of the polymer compound is appropriately determined in consideration of the concentration and type of an organic compound having a phenolic hydroxy group contained in the water to be treated.

The amount of the polymer compound added to water to be treated is preferably 0.25 to 20 times, more preferably 0.5 to 10 times, still more preferably 1 to 10 times, yet more preferably 1 to 5 times the mass of an organic compound having a phenolic hydroxy group contained in the water to be treated. If the organic compound having a phenolic hydroxy group is contained in the water to be treated in an amount of 1 mg/L, the amount of the polymer compound added to the water is preferably 0.25 to 20 mg/L, more preferably 0.5 to 10 mg/L, still more preferably 1 to 10 mg/L, yet more preferably 1 to 5 mg/L.

The addition of the polymer compound in the above amount probably facilitates bonding of the polymer compound to the organic compound having a phenolic hydroxy group contained in the water to be treated, resulting in enhanced dispersion effect.

The scale inhibitor may be added to water to be treated in any amount in the case of addition of the scale inhibitor together with or separately from the dispersant for treatment of water. The amount of the scale inhibitor added to the water to be treated is appropriately determined in consideration of the concentration and type of an organic compound having a phenolic hydroxy group contained in the water and the concentration and type of a scale component contained in the water.

The amount of the scale inhibitor added to water to be treated is preferably 0.25 to 20 times, more preferably 0.5 to 15 times, still more preferably 1 to 10 times the mass of an organic compound having a phenolic hydroxy group contained in the water to be treated.

The amount of the scale inhibitor added to water to be treated is preferably 0.1 to 20 times, more preferably 0.2 to 10 times, still more preferably 0.3 to 5 times the mass of a scale component (e.g., calcium or magnesium) contained in the water to be treated.

The addition of the scale inhibitor in the above amount can significantly reduce the deposition of the organic compound and the scale component onto the surface of the separation membrane during the membrane separation process by the synergistic effect of the dispersant for treatment of water and the scale inhibitor.

For determination of the amount of the polymer compound or scale inhibitor added to water to be treated, the mass (concentration) of an organic compound having a phenolic hydroxy group or a scale component contained in the water is not necessarily determined on the basis of the actual mass (concentration) of the organic compound or scale component contained in the water immediately before addition of the dispersant. For example, the mass of the organic compound or scale inhibitor contained in the water to be treated may be determined on the basis of the mass of the organic compound or scale inhibitor contained in raw water (refer to FIG. 3). The mass of the organic compound contained in the water to be treated may be determined on the basis of the mass of the organic compound added as a flocculant in the flocculation process.

In order to add an appropriate amount of the polymer compound to water to be treated, the amount (concentration) of an organic compound having a phenolic hydroxy group contained in the water is preferably measured before addition of the dispersant containing the polymer compound to the water. The measured value is more preferably monitored. Thus, the amount of the dispersant added to the water to be treated can be determined on the basis of the amount of the organic compound contained in the water.

In order to add an appropriate amount of the scale inhibitor to water to be treated, the amount (concentration) of an organic compound having a phenolic hydroxy group or a scale component contained in the water is preferably measured before addition of the scale inhibitor to the water. The measured value is more preferably monitored. Thus, the amount of the scale inhibitor added to the water to be treated can be determined on the basis of the amount of the organic compound or scale component contained in the water.

The method for treatment of water according to the present embodiment may optionally include a flocculation process involving addition of any known polymer flocculant and/or inorganic flocculant to water to be treated. The method for treatment of water may also include a solid-liquid separation process for the water treated by the flocculation process. Examples of the solid-liquid separation process include a precipitation process, a dissolved air flotation process, a membrane separation process, and a centrifugal process.

The method for treatment of water according to the present embodiment involves the use of the dispersant capable of bonding to an organic compound having a phenolic hydroxy group. Thus, a polymer flocculant (e.g., a flocculant containing an alkali solution of a phenolic resin disclosed in PTL 1) is suitable for use in a process before the addition of the dispersant (e.g., the flocculation process). Even if the flocculant remains in the water treated by flocculation, the addition of the dispersant to the water (i.e., water to be treated) in the subsequent membrane separation process leads to bonding of the dispersant to an organic compound having a phenolic hydroxy group contained in the flocculant, resulting in prevention of membrane fouling.

Examples of the polymer flocculant include, but are not limited to, cationic polymer flocculants, ampholytic polymer flocculants, nonionic polymer flocculants, and anionic polymer flocculants. These polymer flocculants may be used alone or in combination. These polymer flocculants may be commercially available products.

Examples of the inorganic flocculant include, but are not limited to, aluminum salt flocculants, such as aluminum sulfate and polyaluminum chloride; and iron salt flocculants, such as ferrous sulfate, ferric chloride, polyferric sulfate, and iron-silica inorganic polymers (e.g., ferrous salts, ferric salts, and polysilicate iron). One or more inorganic flocculants selected from these may be used.

The method for treatment of water according to the present embodiment preferably includes a process for adjusting the pH of water to be treated to 3.5 to 8.5. The pH of the water to be treated is adjusted more preferably to 4.0 to 7.5, still more preferably to 5.0 to 7.0.

The pH of the water to be treated can be adjusted by any conventional technique using an acid and/or an alkali. Any acid and/or alkali may be used. Examples of the acid include sulfuric acid, hydrochloric acid, and carbon dioxide. Examples of the alkali include sodium hydroxide, sodium carbonate, calcium oxide, calcium hydroxide, and calcium carbonate.

The above-detailed method for treatment of water according to the present embodiment involves addition of the dispersant for treatment of water of the present embodiment or the components of the dispersant to water containing an organic compound having a phenolic hydroxy group. This method can prevent deposition of the organic compound contained in the water onto the surface of a separation membrane. Thus, a reduction in amount of water permeating the membrane, which is caused by the deposition of the organic compound onto the surface of the membrane, can be prevented.

The prevention of deposition of the organic compound contained in the water onto the surface of the separation membrane by the method for treatment of water according to the present embodiment is probably attributed to the mechanism of action of the dispersant for treatment of water described above with reference to FIGS. 2A to 2C.

The method for treatment of water according to the present embodiment may be implemented by a controller including a CPU in an apparatus (e.g., a personal computer) for managing the quality of water to be treated. The method for treatment of water according to the present embodiment may be stored as a program in a hardware source including a recording medium, such as a nonvolatile memory (e.g., a USB flash drive), an HDD, or a CD, and may be implemented by the aforementioned controller. A water treatment system may be provided which is controlled by the controller for adding the dispersant to water to be treated.

The above-detailed present invention includes the following aspects [1] to [13]:

Aspect [1]: A dispersant for treatment of water containing an organic compound having a phenolic hydroxy group, the dispersant comprising a polymer compound having a carbonyl group and a structure including a nitrogen atom bonded to a carbonyl carbon atom.

Aspect [2]: The dispersant according to Aspect [1], wherein the polymer compound comprises at least one of polymer compounds represented by Formulae (1) to (3):

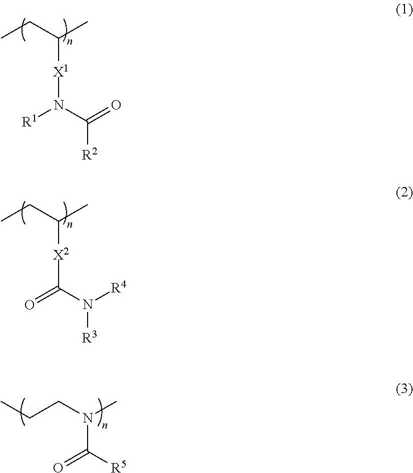

where X¹ and X² each represent a single bond or an alkylene group having one or two carbon atoms and optionally having a substituent; R¹ to R⁵ each represent a hydrogen atom or an alkyl group having one to three carbon atoms and optionally having a substituent; R¹ and R² may be identical to or different from each other and may be bonded together to form a 5- to 7-membered cyclic amide structure; and R³ and R⁴ may be identical to or different from each other and may be bonded together to form a 5- to 7-membered cyclic amide structure.

Aspect [3]: The dispersant according to Aspect [1] or [2], wherein the polymer compound comprises either or both of polyvinylpyrrolidone and polyacrylamide.

Aspect [4]: The dispersant according to any one of Aspects [1] to [3], wherein the polymer compound has a mass average molecular weight of 2,000 to 2,000,000 (more preferably 7,000 to 2,000,000).

Aspect [5]: The dispersant according to any one of Aspects [1] to [4], further comprising a scale inhibitor.

Aspect [6]: The dispersant according to any one of Aspects [1] to [5], for use in a membrane separation process (more preferably, an MF membrane separation process, a UF membrane separation process, an NF membrane separation process, or an RO membrane separation process).

Aspect [7]: A method for treatment of water containing an organic compound having a phenolic hydroxy group, the method comprising adding the dispersant according to any one of Aspects [1] to [6] to the water.

Aspect [8]: The method according to Aspect [7], wherein the water is water to be supplied to a membrane separation process (more preferably, an RO membrane separation process).

Aspect [9]: A method for treatment of water containing an organic compound having a phenolic hydroxy group, the method comprising adding a polymer compound having a carbonyl group and a structure including a nitrogen atom bonded to a carbonyl carbon atom to the water.

Aspect [10]: The method according to Aspect [9], further comprising adding a scale inhibitor to the water.

Aspect [11]: The method according to Aspect [9] or [10], wherein the water is water to be supplied to a membrane separation process (more preferably, an RO membrane separation process) and is treated in a membrane separation process.

Aspect [12]: The method according to Aspect [11], further comprising a flocculation process preceding the membrane separation process, the flocculation process involving addition of a flocculant containing a phenolic resin, wherein the water is water treated by flocculation containing the phenolic-resin-containing flocculant.

### EXAMPLES

The advantageous effects of the present invention will now be described in detail by way of experimental examples, which should not be construed to limit the present invention.

### Experimental Example 1

The following reagents were used in Experimental Example 1.

### (Inorganic Flocculant)

The inorganic flocculant was 3.8 mass % aqueous ferric chloride (FeCl₃) solution.

### (Phenolic Resin Flocculant)

The phenolic resin flocculant was an alkali solution of a phenolic resin. The alkali solution was prepared as disclosed in PTL 1 through addition of formaldehyde to an alkali solution of a novolac phenolic resin, followed by secondary reaction for resol formation in the presence of an alkali catalyst. The phenolic resin contained in the flocculant had a mass average molecular weight of 12,000 in terms of polystyrene and a melting point of 170° C.

### Experimental Example 1-1

Pure water (30 mL) was placed into a sample vial at 25° C. The phenolic resin flocculant was added to the water such that the concentration of the active component was 180 mg/L. Polyvinylpyrrolidone (PVP, mass average molecular weight: 40,000, manufactured by KISHIDA CHEMICAL Co., Ltd.) was then added in an amount of 600 mg/L, and the inorganic flocculant was then added to achieve an FeCl₃ content of 180 mg/L. The pH of the mixture was adjusted to 5.5 with an aqueous sodium hydroxide solution. A mixture of Experimental Example 1-1 was thereby prepared.

### Experimental Example 1-2

A mixture of Experimental Example 1-2 was prepared as in Experimental Example 1-1, except that the PVP used in Experimental Example 1-1 was replaced with PVP (mass average molecular weight: 10,000, manufactured by KISHIDA CHEMICAL Co., Ltd.).

### Experimental Example 1-3

A mixture of Experimental Example 1-3 was prepared as in Experimental Example 1-1, except that the PVP used in Experimental Example 1-1 was replaced with PVP (mass average molecular weight: 2,500, manufactured by Polysciences, Inc.).

### Experimental Example 1-4

A mixture of Experimental Example 1-4 was prepared as in Experimental Example 1-1, except that the PVP used in Experimental Example 1-1 was replaced with PVP (mass average molecular weight: 1,200,000, manufactured by Sigma-Aldrich Corporation).

### Experimental Example 1-5

A mixture of Experimental Example 1-5 was prepared as in Experimental Example 1-1, except that the PVP used in Experimental Example 1-1 was replaced with polyacrylamide (PAAm, mass average molecular weight: 40,000, manufactured by Sigma-Aldrich Corporation).

### Experimental Example 1-6

A mixture of Experimental Example 1-6 was prepared as in Experimental Example 1-1, except that the PVP used in Experimental Example 1-1 was replaced with poly(2-ethyl-2-oxazoline) (mass average molecular weight: 50,000, manufactured by Polysciences, Inc.).

Experimental Examples 1-1 to 1-6 were compared with the following experiments (Experimental Examples 1-7 and 1-8).

### Experimental Example 1-7

A mixture of Experimental Example 1-7 was prepared as in Experimental Example 1-1, except that the PVP used in Experimental Example 1-1 was replaced with an equal amount of pure water.

### Experimental Example 1-8

A mixture of Experimental Example 1-8 was prepared as in Experimental Example 1-1, except that the PVP used in Experimental Example 1-1 was replaced with an equal amount of an aqueous poly(ethylene glycol) solution (mass average molecular weight: 20,000, manufactured by Wako Pure Chemical Industries, Ltd.).

FIG. 4 is a set of photographs (substitute for drawing) of the mixtures of Experimental Examples 1-1, 1-3, 1-7, and 1-8.

In Experimental Example 1-7, the phenolic resin flocculant reacted with FeCl₃ to generate precipitates. In Experimental Example 1-1 (wherein PVP having a mass average molecular weight of 40,000 was added to water to be treated), virtually no flocculation was observed, and the dispersion effect was confirmed. The dispersion effect was also confirmed in Experimental Examples 1-2 and 1-4. The dispersion effect was also confirmed in Experimental Example 1-5 (wherein PAAm having a mass average molecular weight of 40,000 was added to water to be treated). In Experimental Example 1-6 (i.e., the addition of poly(2-ethyl-2-oxazoline) having a mass average molecular weight of 50,000), FeCl₃ did not completely react with the phenolic resin flocculant and the dispersion effect was confirmed, although precipitates were slightly generated as compared with the case of addition of PVP.

In contrast, no dispersion effect was confirmed in Experimental Example 1-3 (i.e., the addition of PVP having a mass average molecular weight of 2,500) or Experimental Example 1-8 (i.e., the addition of poly(ethylene glycol), which is known as a hydrophilic polymer like PVP). These results demonstrated that the dispersant added to water to be treated is required to have a predetermined molecular weight in accordance with the molecular weight, type, and concentration of an organic compound having a phenolic hydroxy group contained in the water.

### Experimental Example 2

The inorganic flocculant used in Experimental Example 1 and a humic acid solution were used in Experimental Example 2. The humic acid solution (180 mg/L) was prepared through dissolution of humic acid (manufactured by Wako Pure Chemical Industries, Ltd.) in 10 mM aqueous NaOH solution.

### Experimental Example 2-1

The humic acid solution (30 mL) was placed in a sample vial at 25° C. PVP having a mass average molecular weight of 40,000 was added in an amount of 600 mg/L, and FeCl₃ was then added in an amount of 180 mg/L. The pH of the mixture was adjusted to 6.0 with a sodium hydroxide solution. A mixture of Experimental Example 2-1 was thereby prepared.

### Experimental Example 2-2

A mixture of Experimental Example 2-2 was prepared as in Experimental Example 2-1, except that the PVP having a mass average molecular weight of 40,000 used in Experimental Example 2-1 was replaced with PAAm having a mass average molecular weight of 40,000.

Experimental Examples 2-1 and 2-2 were compared with the following experiments (Experimental Examples 2-3 and 2-4).

### Experimental Example 2-3

A mixture of Experimental Example 2-3 was prepared as in Experimental Example 2-1, except that the PVP used in Experimental Example 2-1 was replaced with an equal amount of pure water.

### Experimental Example 2-4

A mixture of Experimental Example 2-4 was prepared as in Experimental Example 2-1, except that the PVP used in Experimental Example 2-1 was replaced with an equal amount of an aqueous poly(ethylene glycol) solution (mass average molecular weight: 20,000).

FIG. 5 is a photograph (substitute for drawing) of the mixtures of Experimental Examples 2-1 and 2-3.

In Experimental Example 2-3, humic acid reacted with FeCl₃ to generate precipitates. In Experimental Example 2-1 (wherein PVP was added to water to be treated), virtually no flocculation was observed, and the dispersion effect was confirmed. The dispersion effect was also confirmed in Experimental Example 2-2 (i.e., the addition of PAAm).

### Experimental Example 3

The following test water (water to be treated) and the phenolic resin flocculant used in Experimental Example 1 were used in Experimental Example 3.

### (Water to be Treated)

The water to be treated was brine water from an RO membrane separation apparatus to which biologically treated waste water from a testing laboratory was supplied.

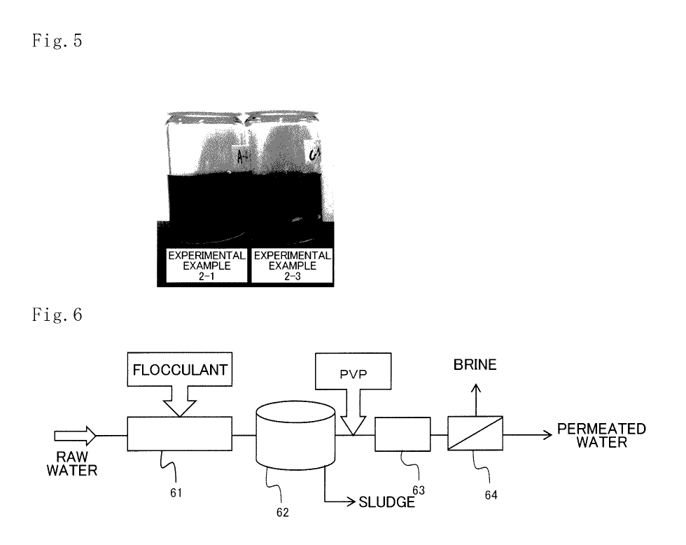

In Experimental Example 3, a simulated water treatment process involving addition of a dispersant (PVP) to water to be treated was performed in a water treatment system including a flocculation apparatus (flocculation process) 61, a solid-liquid separation apparatus (solid-liquid separation process) 62, an MF membrane separation apparatus (MF membrane separation process) 63, and an RO membrane separation apparatus (RO membrane separation process) 64 (see the flow diagram of FIG. 6).

In detail, the dispersion effect of PVP was confirmed in Experimental Example 3 by simulating the case where a phenolic resin (i.e., flocculant) used in the flocculation process 61 remains in an amount of 2 mg/L after the flocculation process 61 and the solid-liquid separation process 62, resulting in contamination of the MF membrane with the phenolic resin.

### Experimental Example 3-1

The water to be treated (500 mL) was placed in a beaker at 25° C. While the water was agitated at 150 rpm for five minutes, the phenolic resin flocculant was added to the water such that the concentration of the active component was 2 mg/L. PVP having a mass average molecular weight of 10,000 was then added in an amount of 0.5 mg/L, and the pH of the mixture was adjusted to 5.5 with hydrochloric acid. The resultant mixture was further agitated at 50 rpm for 10 minutes to cause the reaction between the PVP and the phenolic resin in the water to be treated.

The water prepared through the reaction (250 mL) was subjected to suction filtration with a cellulose MF membrane having a pore size of 0.45 μm at a vacuum of 67 kPa. The time required for the suction filtration was measured.

The water prepared through the reaction was subjected to filtration with a hydrophilic polytetrafluoroethylene (PTFE) syringe filter having a pore size of 0.45 μm for solid-liquid separation. The absorbance of the filtrate was measured at 282 nm with a UV-visible spectrophotometer, to estimate the amount of an organic compound having a phenolic hydroxy group present in the filtrate.

### Experimental Example 3-2

The procedure in Experimental Example 3-2 was performed as in Experimental Example 3-1, except that the PVP used in Experimental Example 3-1 was added in an amount of 1.0 mg/L.

### Experimental Example 3-3

The procedure in Experimental Example 3-3 was performed as in Experimental Example 3-1, except that the PVP used in Experimental Example 3-1 was added in an amount of 2.0 mg/L.

### Experimental Example 3-4

The procedure in Experimental Example 3-4 was performed as in Experimental Example 3-1, except that the PVP used in Experimental Example 3-1 was added in an amount of 4.0 mg/L.

Experimental Examples 3-1 to 3-4 were compared with the following experiments (Experimental Examples 3-5 and 3-6).

### Experimental Example 3-5

The procedure in Experimental Example 3-5 was performed as in Experimental Example 3-1, except that the PVP used in the Experimental Example 3-1 was not added.

### Experimental Example 3-6

The procedure in Experimental Example 3-6 was performed as in Experimental Example 3-1, except that the phenolic resin flocculant and PVP added in Experimental Example 3-1 were replaced with an equal amount of pure water.

Table 1 illustrates the results of Experimental Examples 3-1 to 3-6.

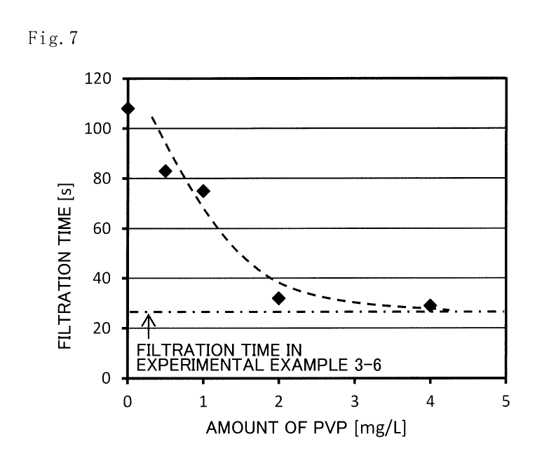

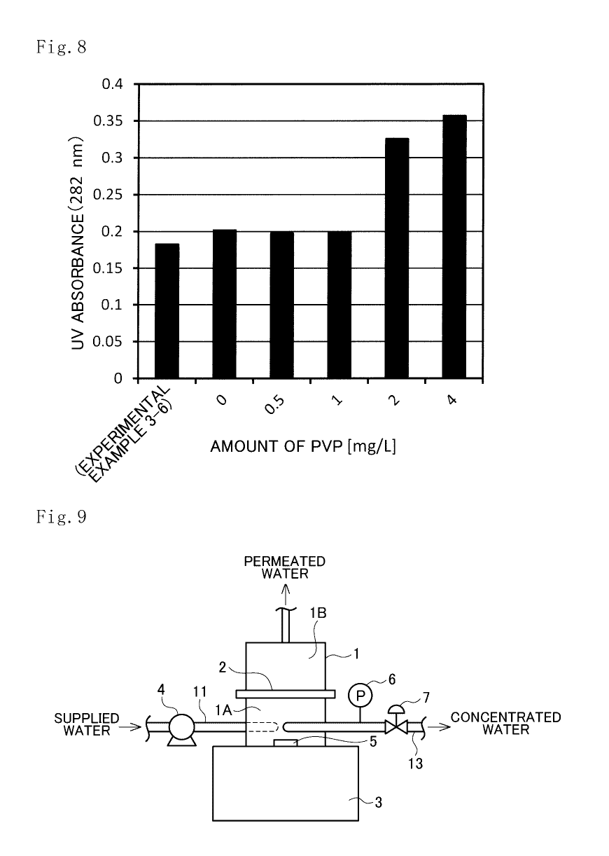

FIGS. 7 and 8 illustrate the relationship between the amount of PVP and the filtration time and the relationship between the amount of PVP and the absorbance at 282 nm, respectively.

TABLE 1

| | Amount of | Amount of | Filtration | |
|---|---|---|---|---|
| Experimental | flocculant | PVP | time | |
| Example No. | [mg/L] | [mg/L] | [s] | Absorbance |
| 3-1 | 2 | 0.5 | 83 | 0.20 |
| 3-2 | 2 | 1.0 | 75 | 0.20 |
| 3-3 | 2 | 2.0 | 32 | 0.33 |
| 3-4 | 2 | 4.0 | 29 | 0.36 |
| 3-5 | 2 | 0.0 | 108 | 0.20 |
| 3-6 | 0 | 0.0 | 26 | 0.18 |

In Experimental Example 3-3 (amount of PVP: 2.0 mg/L) and Experimental Example 3-4 (amount of PVP: 4.0 mg/L), the filtration time was as short as that in Experimental Example 3-6 (refer to FIG. 7), and the absorbance was high at 282 nm (refer to FIG. 8). These results demonstrated that the phenolic resin flocculant passed through the MF membrane (i.e., the membrane was barely contaminated with the flocculant) in Experimental Examples 3-3 and 3-4.

The results of Experimental Example 3 demonstrate that the addition of PVP probably causes the bonding between PVP and the phenolic resin, resulting in prevention of the fouling of a filtration membrane. In particular, the addition of PVP in an amount by mass equal to or greater than that of the active component of the phenolic resin flocculant can prevent deposition of the phenolic resin flocculant onto the MF membrane, resulting in reduced fouling of the MF membrane.

### Experimental Example 4

The test water (water to be treated), reagents, and test conditions used in Experimental Example 4 are as follows.

Canadian Fulvic Acid and calcium chloride were dissolved in pure water to achieve a fulvic acid content of 1 mg/L and a Ca content of 10 mg/L, respectively, to prepare an aqueous fulvic acid solution (pH: 6.5±0.5).

An aqueous solution of PVP having a mass average molecular weight of 10,000 (1 mg/mL) was used as a dispersant for treatment of water.

Kuriverter (registered trademark) N-500 (manufactured by Kurita Water Industries Ltd.) was used as a calcium scale inhibitor.

An ultra-low pressure reverse osmosis membrane ES20 (manufactured by Nitto Denko Corporation) was used as an RO membrane.

The dispersant was evaluated with an RO tester (flat RO membrane tester) including a cell capable of holding an RO membrane having an area of 8 cm² (see FIG. 9). For evaluation of the dispersant with the flat RO membrane tester including a hermetic container 1 having a raw water chamber 1A and a permeated water chamber 1B, water treated by flocculation (i.e., water to be supplied to the RO membrane) was fed to the raw material chamber 1A at a constant rate of 0.7 mL/min through a pipe 11 by use of a high-pressure pump 4, the raw material chamber 1A being disposed below a flat membrane cell 2 holding the RO membrane. During this test, the water in the raw water chamber 1A was agitated with a stirring bar 5 rotated by a stirrer 3. The internal pressure of the hermetic container 1 was adjusted to 0.75 MPa with a pressure gauge 6 and a pressure control valve 7 provided on a pipe 13 for discharging concentrated water. The permeation flux was determined at a recovery rate of 80% and a water temperature of 25±2° C.

The recovery rate and the permeation flux were determined by the following expressions:

Recovery rate [%]=(flow rate of permeated water [mL/min]/flow rate of supplied water [mL/min])×100

Permeation flux [m³/(m²d)]=(flow rate of permeated water [m³/d]/membrane area [m²])×temperature conversion factor

### Experimental Example 4-1

PVP was added to the aqueous fulvic acid solution (Ca added) in an amount of 1 mg/L, and the resultant test water was subjected to the flat membrane test. During the test, the operating pressure was controlled with the valve to maintain a recovery rate of 80%, and the permeation flux was recorded after the elapse of a certain period of time.

### Experimental Example 4-2

PVP was added to the aqueous fulvic acid solution (Ca added) in an amount of 1 mg/L, and Kuriverter N-500 was then added to the solution in an amount of 10 mg/L. The resultant test water was subjected to the flat membrane test. The remaining procedure was as in Experimental Example 4-1.

Experimental Examples 4-1 and 4-2 were compared with the following experiment (Experimental Example 4-3).

### Experimental Example 4-3

The flat membrane test was performed as in Experimental Example 4-1, except that PVP and Kuriverter N-500 were not added to the aqueous fulvic acid solution (Ca added).

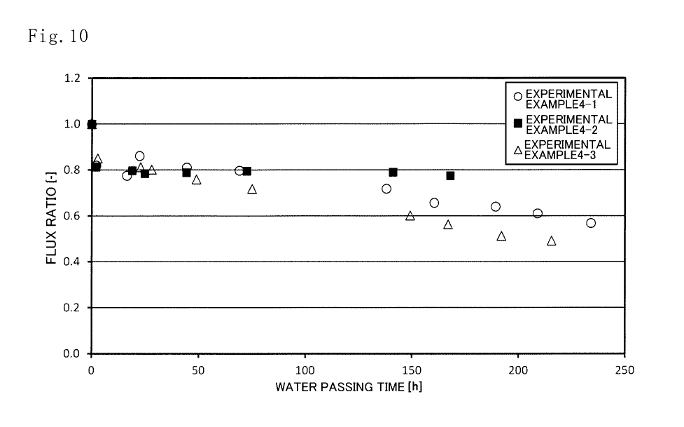

FIG. 10 illustrates a graph of the ratio of permeation fluxes plotted against the water passing time in Experimental Examples 4-1 to 4-3.

A reduction in flux was observed in Experimental Example 4-3. This phenomenon is probably attributed to the fact that calcium added to fulvic acid causes bonding of calcium ions to carboxy groups of fulvic acid, leading to ionic crosslinking and deposition of fulvic acid and calcium onto the surface of the membrane.

In Experimental Examples 4-1 and 4-2, a reduction in flux was suppressed through addition of PVP to the water to be treated, as compared with Experimental Example 4-3. These results demonstrate that the dispersant (PVP) exhibits advantageous effects on naturally occurring organic compounds having a phenolic hydroxy group (e.g., humic substances). The addition of the calcium scale inhibitor besides PVP breaks the crosslinked structure of fulvic acid, resulting in a significant dispersion effect of PVP (Experimental Example 4-2).

1. A dispersant for treatment of water containing an organic compound having a phenolic hydroxy group, the dispersant comprising a polymer compound having a carbonyl group and a structure including a nitrogen atom bonded to a carbonyl carbon atom.

2. The dispersant according to claim 1, wherein the polymer compound comprises at least one of polymer compounds represented by Formulae (1) to (3): 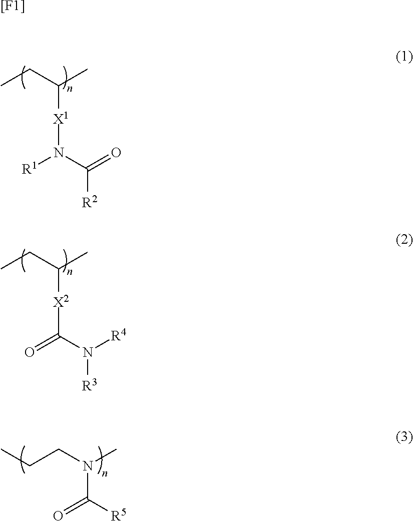
where X¹ and X² each represent a single bond or an alkylene group having one or two carbon atoms and optionally having a substituent; R¹ to R⁵ each represent a hydrogen atom or an alkyl group having one to three carbon atoms and optionally having a substituent; R¹ and R² may be identical to or different from each other and may be bonded together to form a 5- to 7-membered cyclic amide structure; and R³ and R⁴ may be identical to or different from each other and may be bonded together to form a 5- to 7-membered cyclic amide structure.

3. The dispersant according to claim 1, wherein the polymer compound comprises polyvinylpyrrolidone and/or polyacrylamide.

4. The dispersant according to claim 1, wherein the polymer compound has a mass average molecular weight of 7,000 to 2,000,000.

5. The dispersant according to claim 1, further comprising a scale inhibitor.

6. The dispersant according to claim 1, for use in a membrane separation process.

7. A method for treatment of water containing an organic compound having a phenolic hydroxy group, the method comprising adding the dispersant according to claim 1 to the water.

8. The method according to claim 7, wherein the water is water to be supplied to a membrane separation process.
